(19) United States
(12) Patent Application Publication
(10) Pub. No.: US 2003/0088751 A1
(43) Pub. Date: May 8, 2003

(54) Memory read/write arbitrating apparatus and method

(76) Inventors: Sheng-Chung Wu, Hsin Tien City (TW); Jiin Lai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/195,536

(22) Filed: Jul. 16, 2002

(30) Foreign Application Priority Data
Nov. 2, 2001 (TW) 90127260

(51) Int. Cl. G06F 12/00

(52) U.S. Cl. 711/167; 711/105; 711/154

(57) ABSTRACT

The present invention discloses a memory read/write arbitrating apparatus and method, which arbitrates a plurality of reading and writing requests from the CPU. The arbitrating apparatus includes a writing queue and a reading queue, a comparator, and an arbitrator. Before one writing request sending from CPU stored to the writing queue, the comparator compares the current writing request address with a previous one writing request address. Then, the comparison result and the writing request are stored in the writing queue. If the comparison result shows that the current writing request address belongs to the different memory page but to the same memory sub-bank with the previously executed writing request address and at least one reading request is present in the reading queue, the reading request will be executed preferentially.

### FIELD OF THE INVENTION

The present invention relates to a memory read/write arbitrating apparatus and method, especially to a memory read/write arbitrating apparatus and method for dealing with two successive writing requests that write into the same memory sub-bank but the different memory page.

### BACKGROUND OF THE INVENTION

In a general computer system, a CPU is coupled with a controller to deal with requests from the CPU. These requests from the CPU are classified by the controller and then sent to related devices such as a memory, an AGP (accelerated graphic port) device or other peripheral devices. Moreover, the controller is generally provided with a plurality of FIFO queues to store the requests temporarily and manage them to be transferred between CPU and other devices efficiently. FIG. 1 shows a schematic view of a conventional controller with an arbitrator 30, a writing queue 10 and a reading queue 40. When the CPU has requested for successive access to the memory, these requests are stored in the writing queue 10 or the reading queue 40. More particularly, the reading requests are sequentially stored in the reading queue 40 and the writing requests are sequentially stored in the writing queue 10. The reading queue 40 and the writing queue 10 are FIFO (first in first out) queues. The arbitrator 30 is coupled with the writing queue 10 and the reading queue 40 and executes the requests stored in those queues to the memory to complete the transactions between the CPU and the memory.

In general, the reading requests have higher priorities than the writing requests. Because the CPU needs the responding reading data to executing the following commands, a reading operation is not completed until the responding reading data is sent to the CPU from the memory. On the contrary, the CPU regards a writing operation is completed as long as the controller has a proper queue to store the writing requests and data. When controller receives a writing request, it is able to respond the CPU that the writing requested is completed no matter the corresponding writing request is sent to the memory or not. FIG. 2 shows the control flowchart of the conventional arbitrator. The conventional flowchart of FIG. 2 including following steps:

Step 102: count of the writing requests in the writing queue more than an upper limit; if true, go to step 104, else, go to step 110;

Step 104: the arbitrator executing a writing request in the writing queue;

Step 106: count of the writing request in the writing queue less than a lower limit; if true, back to step 102, else, back to step 104;

Step 110: reading request present in the reading queue; if yes, go to Step 112, if not, back to Step 102;

Step 112: executing a reading request in the reading queue and back to Step 102.

As aforementioned steps, the arbitrator executes the writing requests in the writing queues only when they exceed the upper limit until less than the lower limit. Once count of the writing requests exceeds the upper limit, the arbitrator successively sends the writing requests until the count is less than the lower limit. The reading requests are preferentially sent by the arbitrator in case that the number of the writing requests in the writing queue does not exceed the upper limit. When the writing requests are successively executed and the CPU is issuing reading requests, the reading requests are temporarily stored in the reading queues until the number of writing requests less than the lower limit.

The memory is generally divided into a plurality of memory sub-banks and each sub-bank includes a plurality of memory pages. The memory determines where to access the requests respectively according to their corresponding addresses. If two successive request addresses are not in the same memory page, the controller has to asserted the pre-charge, activate and command signals to the memory through the control line thereof. If two successive request addresses are in the same memory page, the controller only asserts the command signals to the memory.

FIGS. 3A, 3B and 3C demonstrate the timing diagram for memory access operations for three different situations. FIG. 3A demonstrates the case that the physical addresses of successive writing requests are in the same memory page of the same memory sub-bank. The successive writing requests are sent through the control line, so that the data corresponding to these writing requests can be written following the command signals on the data lines. FIG. 3B demonstrates the case that the physical addresses of successive writing requests are in different memory sub-banks and memory pages. Once the first correspond data following the first command signal, a pre-charge signal belonging to the next request can be asserted on the control line at the same time. Because two successive writing request addresses belong to different memory sub-banks and memory pages, pre-charge, activate, and command signals are sequentially asserted on the control lines. FIG. 3C demonstrates the case that the physical addresses of the memory for successive writing requests are in different memory pages, namely off-page, of the same memory sub-bank. As shown in this figure, after the first corresponding data is written, the control line is available for the next request. That is, once the first transaction is completed, the pre-charge, activate, and command signals for the next writing request can be sent to the control line. In other words, the case that the physical addresses of the memory for successive requests are in different memory pages of the same memory sub-bank has the largest latency.

More particularly, when the physical addresses of the memory for two successive writing requests are in different memory pages but in the same memory sub-bank, the arbitrator has to assert a pre-charge signal, an activate signal, and a command signal after completing the preceding writing transaction. In the mean time, if a reading request is present in the reading queue, the reading request still wait for completing the writing requests to a lower limit and it leads to deterioration of the system performance.

### SUMMARY OF THE INVENTION

It is the object of the present invention to provide a memory read/write arbitrating apparatus, connected between a CPU and a memory, for arbitrating a plurality of reading and writing requests from the CPU. The arbitrating apparatus includes a writing queue, a reading queue, a comparator, and an arbitrator. The writing queues are connected to the CPU and used to store the writing requests. The comparator is connected to the CPU and the writing queues and used to compare a current and previous writing request to generate a comparison result. The comparison result is recorded in the writing queue with the writing requests. The reading queues are connected to the CPU and used to store the reading requests of the CPU. When the current writing request address belongs to the different memory page but the same memory sub-bank in comparison with the previous writing request address and a reading request is present in the reading queue, the reading request will be executed preferentially.

The present invention further provides a memory read/write arbitrating method for arbitrating a plurality of reading and writing requests from the CPU. The memory, for example, is a dynamic random access memory (DRAM) and is divided into a plurality. of memory sub-banks. Each sub-bank is divided into a plurality of memory pages. The arbitrating method includes following steps:

comparing a current writing request address with a previous writing request address to generate a comparison result, which is stored in a writing queue with the current writing request; and

executing a reading request if the comparison result shows the current and previous writing request are in the same memory sub-bank but not in the same memory pages and the reading request is present.

The various objects and advantages of the present invention will be more readily understood from the following detailed description when read in conjunction with the appended drawing, in which:

### BRIEF DESCRIPTION OF DRAWING

FIG. 1 shows a schematic view of a conventional controller.

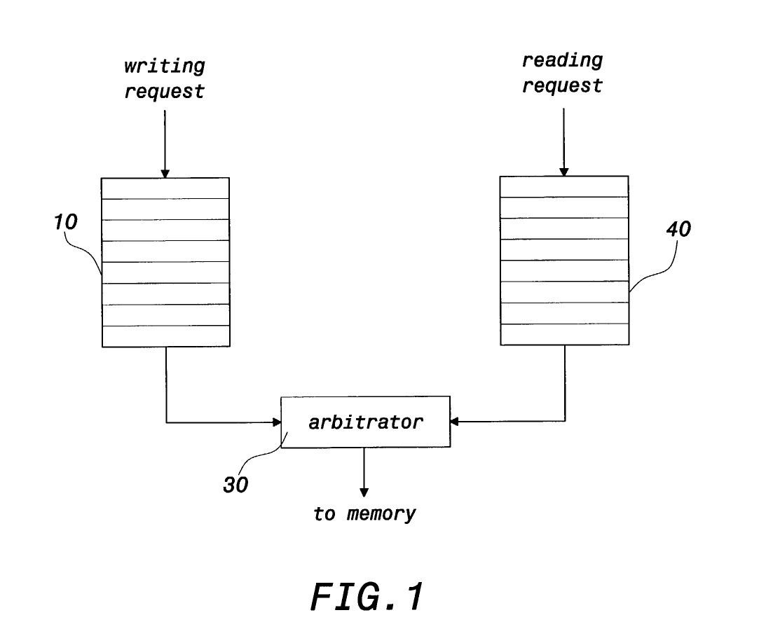

FIG. 2 shows the control flowchart of the conventional arbiter.

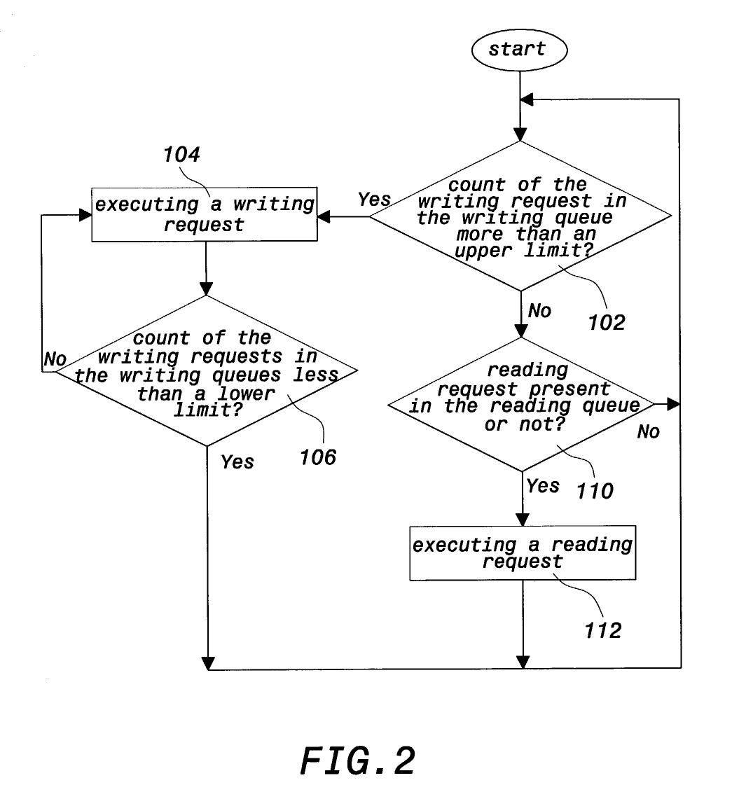

FIGS. 3A, 3B and 3C demonstrate the timing diagram for memory access operations in three different situations respectively.

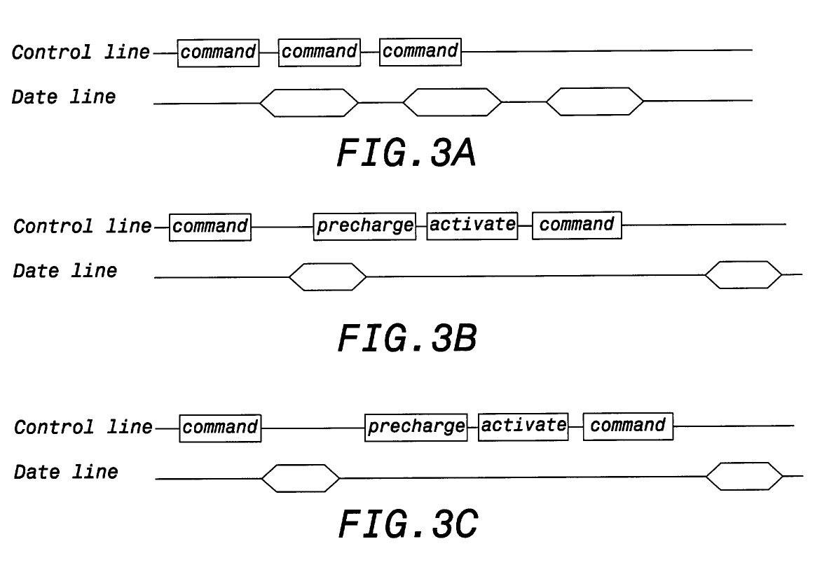

FIG. 4 shows the schematic view of the inventive controller.

FIG. 5 shows the control flowchart of the arbitrating method of the present invention.

### DETAILED DESCRIPTION OF THE INVENTION

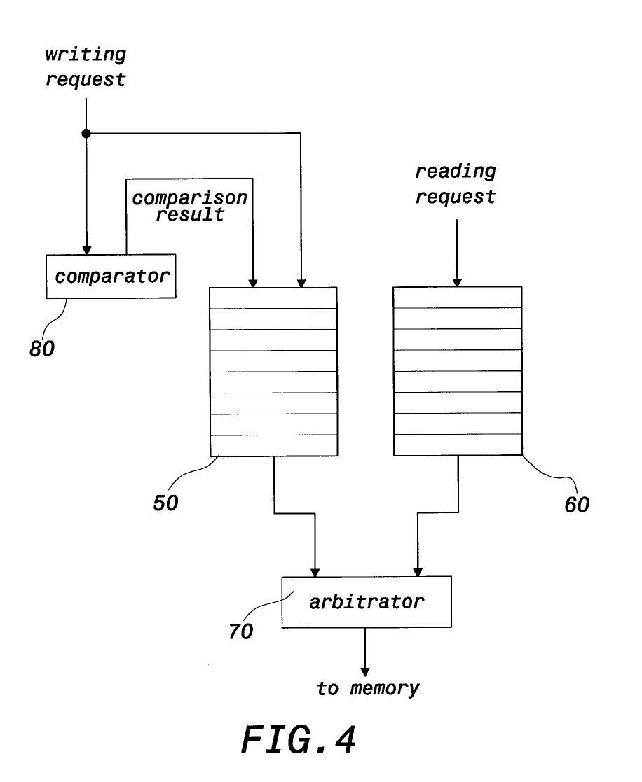

FIG. 4 shows the schematic view of the inventive controller with arbitrating apparatus and related queues connected between a CPU (not shown) and a memory (not shown). The read/ write operations of the CPU to the memory are arbitrated by the arbitrating apparatus. The arbitrating apparatus according to the present invention includes a writing queue 50, a comparator 80, a reading queue 60 and an arbitrator 70. The writing queue 50 is connected to the CPU and stores the writing requests from the CPU. The comparator 80 is connected between the CPU and the writing queue 50 for comparing two successive writing requests addresses to generate a comparison result for discriminating their corresponding memory sub-bank and memory page. The comparison result is recorded in the writing queue 50 together with the writing request. The reading queue 60 is connected to the CPU and stores the reading requests from the CPU. The arbitrator 70 is connected both to the reading queue 60 and the writing queue 50. The arbitrator 70 determines to execute the writing or reading requests according to the content of the reading queue 60 and the writing queue 50. In the present invention, when the second writing address belong to different memory page of the same memory sub-bank comparing with the first executed writing request and at least one reading request is present in the reading queue 60, the arbitrator 70 will stop the second writing request and execute the reading request in the reading queue 60 preferentially.

More particularly, when the second address of writing request belongs to different memory page but the same memory sub-bank comparing with the previous one, the arbitrator 70 should issue pre-charge, activate, and command signals for the second writing request after completing the first request. If a reading request is present in the reading queue 60, in the worse case the arbitrator also asserts the pre-charge, activate, and command signals for executing the reading request. In the better case, when the reading request has the same memory page of the same memory sub-bank comparing with the first writing request, the arbitrator can only assert command signal to get responding reading data. Or, when the reading request has the different memory sub-bank and memory page with the first writing request, the arbitrator can assert the pre-charge signal at the time that the first writing data appears on the data line. In this way, the arbitrator can use less latency to get the responding reading data from the memory. In any cases described above, the reading request will be executed with the priority, the responding reading data can be efficiently sent back to the CPU regardless of count of the writing queues is less than a lower limit.

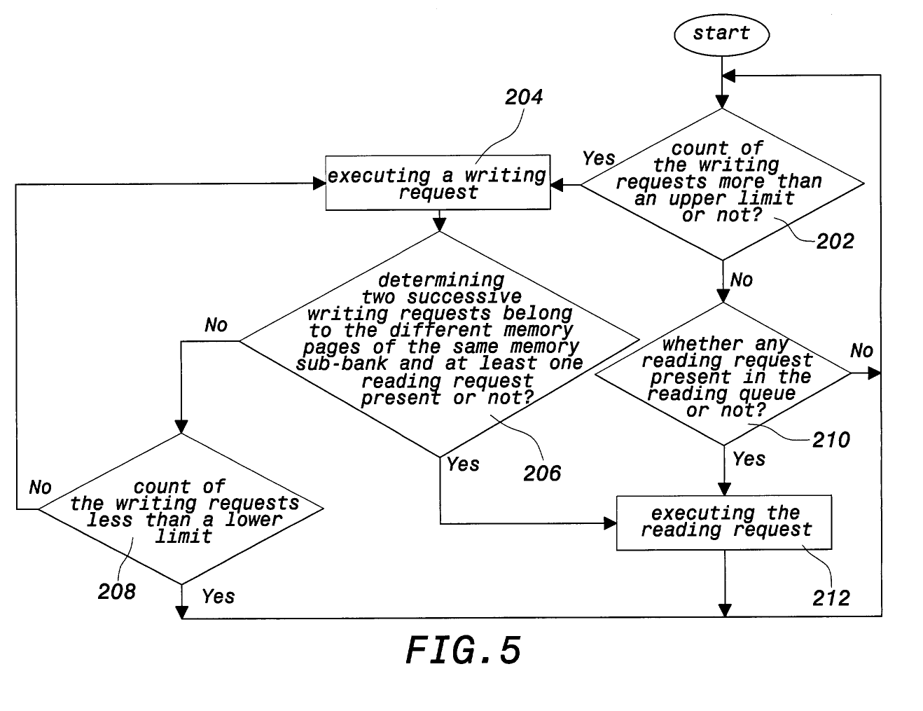

FIG. 5 shows the control flowchart of the arbitrating method of the present invention. The arbitrating method including following steps:

Step 202: count of the writing requests in the writing queue more than an upper limit; if true, go to step 204; else, go to step 210;

Step 204: executing a writing request in the writing queue;

Step 206: determining a address of a current writing request with the different memory page of the same memory sub-bank in comparison with the previous writing request and at least one reading request is present in the reading queue; if true, go to step 212; else, go to step 208;

Step 208: count of the writing requests in the writing queue less than a lower limit; if true, go to step 202, else, go to step 204;

Step 210: whether any reading request is present in the reading queue; if true, go to step 212, else, go to step 202; and

Step 212: executing the reading request and then back to step 202.

To sum up, in the present invention, when the address of a current writing request belongs to different memory page of the same sub-bank in comparison with the previous writing request and at least one reading request is present in the reading queue, the reading request is executed for reducing the turn around cycle of the memory and enhancing the system efficiency.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim

1. A memory read/write arbitrating apparatus, connected to a CPU and a memory, for arbitrating a plurality of reading and writing requests from the CPU to the memory, the arbitrating apparatus comprising:
a writing queue for storing the writing requests;
a comparator, connected between the CPU and the writing queue, for comparing a current writing request address and a previous writing request address to generate a comparison result and storing the comparison result together with the current writing request to the writing queue;
a reading queue for storing the reading requests; and
an arbitrator connected to the reading queue and the writing queue;
wherein the arbitrator gives the priority to execute at least one reading request if the comparison result shows the current writing address and previously executed writing address belong to a same memory sub-bank but not to a same memory page and the at least one reading request is present.

2. The arbitrating apparatus as in claim 1, wherein the memory is a dynamic random access memory (DRAM).

3. The arbitrating apparatus as in claim 1, wherein the reading queue is a FIFO (first in first out) queue.

4. The arbitrating apparatus as in claim 1, wherein the writing queue is a FIFO (first in first out) queue.

5. A memory read/write arbitrating apparatus, connected to a CPU and the memory, for arbitrating a plurality of reading and writing requests from the CPU to the memory, the arbitrating apparatus comprising:
a comparator comparing a current writing request address with a previous writing request address to generate a comparison result; and
an arbitrator;
wherein the arbitrator gives the priority to execute at least one reading request when the comparison result shows the current writing request address and the previously executed writing request address belong to a same memory sub-bank but not to a same memory page and the at least one reading request is present.

6. The arbitrating apparatus as in claim 5, wherein the memory is a dynamic random access memory (DRAM).

7. The arbitrating apparatus as in claim 5, further comprising:
a writing queue, connected between the CPU and the arbitrator, for storing the writing requests and the comparison result; and
a reading queue, connected between the CPU and the arbitrator, for storing the reading requests.

8. The arbitrating apparatus as in claim 7, wherein the writing queue is a FIFO (first in first out) queue.

9. The arbitrating apparatus as in claim 7, wherein the reading queue is a FIFO (first in first out) queue.

10. A memory read/write arbitrating method comprising following steps:
comparing a current writing request address and a previous writing request address to generate a comparison result; and
executing at least one reading request if the comparison result of a second writing request for two successive writing requests shows the second writing request address and a executed first writing request address belong to a same memory sub-bank but not to a same memory page and at least one reading request is present.

11. The arbitrating method as in claim 10, wherein the memory is a dynamic random access memory (DRAM).

12. A memory read/write arbitrating method comprising following steps:
comparing a current writing request address with a previous writing request address to generate a comparison result;
storing the comparison result together with a current writing request to a writing queue; and
executing at least one reading request if the comparison result of a second writing request for two successive writing requests shows the second writing request address and a first executed writing request address belong to a same memory sub-bank but not to a same memory page and at least one reading request is present.

13. The arbitrating method as in claim 12, wherein the writing queue is a FIFO (first in first out) queue.

14. The arbitrating method as in claim 12, wherein the comparison result is generated by a comparator.

15. The arbitrating method as in claim 12, wherein the memory is a dynamic random access memory (DRAM).
